(19) United States
(12) Patent Application Publication
(10) Pub. No.: US 2023/0249662 A1
(43) Pub. Date: Aug. 10, 2023

(54) METHOD AND DEVICE FOR FAILURE DETECTION OF VACUUM SENSOR, DETECTION DEVICE, AND METHOD FOR FAILURE PROCESS OF VACUUM SENSOR

(71) Applicant: GUANGZHOU AUTOMOBILE GROUP CO., LTD., Guangzhou (CN)

(72) Inventors: Xuan Luo, Guangzhou (CN); Weidong Zhang, Guangzhou (CN); Dongxu YI, Guangzhou (CN); Yang Cui, Guangzhou (CN)

(21) Appl. No.: 18/012,811

(22) PCT Filed: Jun. 12, 2021
(86) PCT No.: PCT/CN2021/099909

§ 371 Date: Dec. 23, 2022

(30) Foreign Application Priority Data
Jun. 24, 2020 (CN) 202010586335.1

(51) Int. Cl. B60T 17/22; B60T 13/46

(52) U.S. Cl. CPC B60T 17/22; B60T 13/46

(57) ABSTRACT

A method and device for failure detection of vacuum sensor is disclosure. The method includes: S1: obtaining a first vacuum pressure when a brake pedal is validly stamped; S2: determining whether a braking action by the brake pedal is maintained, wherein next S3 is performed if yes, and a detection is stopped if not; S3: obtaining a second vacuum pressure when the brake pedal is validly released; and S4: determining whether the second vacuum pressure is within a variable range of the first vacuum pressure, wherein the vacuum sensor is determined to have failed if yes; and, the vacuum sensor is determined to have not failed. The disclosure performs a logical control, and determines whether the vacuum sensor is blockage or failure, thus safety in traffic is ensured, and accidents that the braking action fails due to the blockage or failure of the vacuum sensor is avoided.

### FIELD

The subject matter herein generally relates to vehicle technology, and particularly to a method and a device for failure detection of vacuum sensor, and a method for failure process of vacuum sensor.

### BACKGROUND

To encourage immerging technologies of alternative powered vehicles by country to take environmental protection into account, sectors of the alternative powered vehicles are experiencing an explosive growth. Since some new vehicles have no engine to create a vacuum, thus a braking system must employ an electrical vacuum pump as the main source of the vacuum. Controlling of the vacuum pump by a vehicle control unit (VCU) mainly depends on a signal of the pressure provided by the vacuum sensor. However, when the signal is blocked, an error judgment by the VCU may occur, even though the vacuum pump functions normally, consequently causing a safety accident when the brakes of a vehicle are not braking-boosted. Thus, a detection of the vacuum sensor relates to a safety of the whole vehicle, which is crucial. An effective method of detecting and preventing a blockage or failure of the vacuum sensor is urgently needed in the industry.

### SUMMARY

An embodiment of the present application provides a method for failure detection of vacuum sensor, a device for failure detection of vacuum sensor, and a method for failure process of vacuum sensor, which are capable of safely and reliably detecting whether a vacuum sensor fails.

In a first aspect, an embodiment of the present application provides a method for failure detection of vacuum sensor. The method for failure detection of vacuum sensor includes:

S1: obtaining a first vacuum pressure when a brake pedal is validly stamped;

S2: determining whether a braking action by the brake pedal is maintained, wherein next S3 is performed during the braking action by the brake pedal being maintained if the braking action by the brake pedal is maintained, and the detection is stopped if the braking action by the brake pedal is not maintained;

S3: obtaining a second vacuum pressure when the brake pedal is validly released; and

S4: determining whether the second vacuum pressure is within a variable range of the first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure.

According to some embodiments of the present application, obtaining a first vacuum pressure when a brake pedal is validly stamped in S1 includes:

S11: determining that the brake pedal is validly stamped when a pressure of a main cylinder being greater than a preset first threshold, a travel distance of the brake pedal being greater than a preset second threshold, and a speed of a change of pressure of the main cylinder being greater than a preset third threshold are maintained during a preset period; and

S12: obtaining a maximum vacuum pressure and a minimum vacuum pressure during the preset period.

According to some embodiments of the present application, a condition of the braking action by the brake pedal being determined to have maintained in S2 includes: a brake lamp switch being on, and either a travel of the brake pedal is greater than a preset fourth threshold or the pressure of the main cylinder is greater than a preset fifth threshold.

According to some embodiments of the present application, obtaining a second vacuum pressure when the brake pedal is validly released in S3 includes:

S31: when the brake pedal is released, determining that the release is valid and controlling a counter to add one, if a speed of the change of pressure of the main cylinder is greater than a preset sixth threshold and the travel distance of the brake pedal is greater than a preset seventh threshold; and determining that the release is valid and controlling the counter to add two, if the speed of the change of pressure of the main cylinder is greater than a preset eighth threshold and the travel distance of the brake pedal is greater than a preset ninth threshold;

S32: controlling the counter to increase from zero, where the counter is reset and restarted from zero if conditions in S31 are not met when the brake pedal is released;

S33: obtaining a current vacuum pressure if the counter is greater than a preset tenth threshold.

In a second aspect, an embodiment of the present application provides a device for failure detection of vacuum sensor. The device includes a first pressure obtaining module, a first determining module, a second pressure obtaining module, and a second determining module, where;

The first pressure obtaining module is configured to obtain a first vacuum pressure when a brake pedal is validly stamped;

The first determining module is configured to determine whether a braking action by the brake pedal is maintained, wherein next S3 is performed during the braking action by the brake pedal is maintained if the braking action by the brake pedal is maintained, and the detection is stopped if the braking action by the brake pedal is not maintained;

The second pressure obtaining module is configured to obtain a second vacuum pressure when the brake pedal is validly released;

The second determining module is configured to determine whether the second vacuum pressure is within a variable range of a first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure.

According to some embodiments of the present application, the first pressure obtaining module includes a validity determining unit and a pressure obtaining unit, where;

The validity determining unit is configured to determine that the brake pedal is validly stamped when a pressure of a main cylinder being greater than a preset first threshold, a travel distance of the brake pedal being greater than a preset second threshold, and a speed of a change of the pressure of the main cylinder being greater than a preset third threshold are maintained during a preset period;

The pressure obtaining unit is configured to obtain a maximum vacuum pressure and a minimum vacuum pressure during the preset period.

According to some embodiments of the present application, a condition of the braking action by the brake pedal being determined to have maintained in the first determining module includes: a brake lamp switch being on, and either a travel of the brake pedal is greater than a preset fourth threshold or the pressure of the main cylinder is greater than a preset fifth threshold.

According to some embodiments of the present application, the second determining module includes a distinguishing unit, a counting unit, and an obtaining unit, where;

When the brake pedal is released, the distinguishing unit is configured to determine that the release is valid and control a counter to add one, if a speed of the change of the pressure of the main cylinder is greater than a preset sixth threshold and the travel distance of the brake pedal is greater than a preset seventh threshold; and also to determine that the release is valid and control the counter to add two if the speed of change of pressure of the main cylinder is greater than a preset eighth threshold and the travel distance of the brake pedal is greater than a preset ninth threshold;

The counting unit is configured to control the counter to increase from zero, where the counter is reset and restarted from zero if conditions in S31 are not met when the brake pedal is released;

The obtaining unit is configured to obtain a current vacuum pressure if the counter is greater than a preset tenth threshold.

In a third aspect, an embodiment of the present application provides a method for failure process of vacuum sensor, such method includes:

Controlling a vacuum pump to repeat in a cycle of operations comprising closing for a preset duration and opening again when the vacuum sensor is determined to have failed.

According to some embodiments of the present application, the method further includes:

Limiting a highest speed per hour of a vehicle, and/or generate a failure prompt to a driver.

Compared with traditional art, the present disclosure has the following beneficial effects:

The disclosure performs a logical control according to a stamp-release signal of the brake pedal, a travel signal of the brake pedal, a pressure signal of the main cylinder, an operation signal of the electrical vacuum pump, and so on, and determines whether the vacuum sensor is blockage or failure or otherwise, thus safety in traffic is ensured, and accidents that the braking action fails due to the blockage or failure of the vacuum sensor can be avoided. The disclosure not only generates, upon the vacuum sensor failure, an alarm to prompt the driver but also performs a speed limit control on the vehicle after detecting such failure.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of an embodiment of a method for failure detection of vacuum sensor according to the present disclosure.

FIG. 2 is a block diagram of an embodiment of a device for failure detection of vacuum sensor according to the present disclosure.

### DETAILED DESCRIPTION

Implementations of the disclosure will now be described, by way of embodiments only, with reference to the drawings. The disclosure is illustrative only, and changes may be made in the detail within the principles of the present application. It will, therefore, be appreciated that the embodiments may be modified within the scope of the claims.

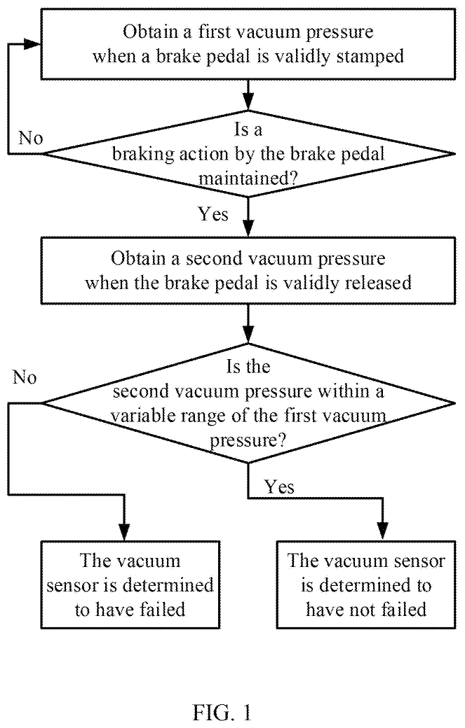

FIG. 1 is a flowchart of an embodiment of a method for failure detection of vacuum sensor. The method can include the following steps:

S1: obtaining a first vacuum pressure when a brake pedal is validly stamped;

S2: determining whether a braking action by the brake pedal is maintained, wherein next S3 is performed during the braking action by the brake pedal being maintained if the braking action by the brake pedal is maintained, and the detection is stopped if the braking action by the brake pedal is not maintained;

S3: obtaining a second vacuum pressure when the brake pedal is validly released; and

S4: determining whether the second vacuum pressure is within a variable range of the first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure.

In the embodiment, the vacuum pressures of the brake pedal in different working states are obtained and compared, and whether the vacuum sensor occurs a blockage or failure is determined, thus a safety in traffic can be ensured, and accidents that the braking action fails due to the blockage or failure of the vacuum sensor can be avoided. The detection can be stopped for a preset time when the vacuum sensor is detected to have no failure and the vacuum sensor can be detected again.

In one embodiment of the present application, obtaining the first vacuum pressure when the brake pedal is validly stamped in S1 includes:

S11: determining that the brake pedal is validly stamped when a pressure of a main cylinder being greater than a preset first threshold, a travel distance of the brake pedal being greater than a preset second threshold, and a speed of a change of the pressure of the main cylinder being greater than a preset third threshold are maintained during a preset period,; and

S12: obtaining a maximum vacuum pressure and a minimum vacuum pressure during the preset period.

In the embodiment, a logical control can be performed according to an obtained signal of the pressure of the main cylinder, an obtained signal of the brake pedal, an obtained vacuum pressure, and so on. When the obtained vacuum pressure is greater than a low vacuum alarm threshold, namely, when a vacuum degree is low, the disclosure does not determine whether the brake pedal is validly stamped, but a low vacuum alarm is directly performed, and the detection is stopped. Each threshold can be calibrated and set according to own characteristic. For example, the pressure of the main cylinder relates to characteristic of a vacuum booster, and the threshold can be 10 bar˜30 bar. An validity of a determination of the operation that the brake pedal is stamped can be ensured via a dual redundancy of the stamp-release signal of the brake pedal and the travel signal of the brake pedal.

In one embodiment of the present application, a condition of the braking action by the brake pedal being determined to have maintained in S2 includes: a brake lamp switch being on, and either a travel of the brake pedal is greater than a preset fourth threshold or the pressure of the main cylinder is greater than a preset fifth threshold.

In the embodiment, the instant detection logic can be pushed if the determination of the braking action by the brake pedal being determined to have maintained is not true, and the detection procedure can be stopped for a preset time and be started again. Each threshold in the condition of the braking action by the brake pedal being determined to have maintained can be calibrated and set according to own characteristic, and the stopped preset time can be also calibrated and set.

In one embodiment of the present application, obtaining the second vacuum pressure when the brake pedal is validly released in S3 includes:

S31: when the brake pedal is released, determining that the release is valid and controlling a counter to add one, if a speed of the change of the pressure of the main cylinder is greater than a preset sixth threshold and the travel distance of the brake pedal is greater than a preset seventh threshold; and determining that the release is valid and controlling the counter to add two, if the speed of the change of pressure of the main cylinder is greater than a preset eighth threshold and the travel distance of the brake pedal is greater than a preset ninth threshold;

S32: controlling the counter to increase from zero, where the counter is reset and restarted from zero if conditions in S31 are not met when the brake pedal is released;

S33: obtaining a current vacuum pressure if the counter is greater than a preset tenth threshold.

In the embodiment, the detection of the process S3 is performed based on that S1 and S2 are true. Each threshold in the process can be calibrated and set according to own characteristic

The embodiment provides a method for failure detection of the vacuum sensor, which can obtain the signal of the pressure of the main cylinder, the signal of the brake pedal, and a signal of the vacuum pressure. When the brake pedal is quickly stamped, if a variable range of the vacuum pressure is within a range of from −1.5 kPa (calibratable) to 1.5 kPa (calibratable), and if the vacuum pressure is still within the range when the brake pedal is released, the vacuum sensor is determined to have blockage. The method can include the following steps:

M1: determining whether a stamping and braking action is validly; wherein a variation range of the vacuum pressure is recorded if the stamping and braking action is validly, which specifically includes:

M11: the pressure of the main cylinder is greater than 10 bar 30 bar (being relates to the characteristic of the vacuum booster, and being calibratable);

M12: the vacuum pressure is greater than the low vacuum alarm threshold (namely, when the vacuum degree is low, the detection is stopped, and the low vacuum alarm is directly performed);

M13: the speed of the change of the pressure of the main cylinder is greater than 30 bar/s˜50 bar/s (calibrated) and the travel distance of the brake pedal is greater than 10% (calibrated);

M14: if the above conditions are satisfied in a successive 15˜30 operation cycles (each operation cycle is 15 ms and a conversion time is 300 ms˜600 ms, which are calibrated), obtaining a maximum vacuum pressure pabsmax and a minimum vacuum pressure pabsmin during this period.

M2: determining whether the braking action by the brake pedal is maintained, wherein next S3 is performed repeatedly during the brake action by the brake pedal being maintained if the braking action by the brake pedal is maintained; and the logic for the blockage of the vacuum sensor is quitted if the braking action by the brake pedal is not maintained, and the detection is stopped for 200 ms˜500 ms (calibratable) and restarting the blockage detection again if the braking action by the brake pedal is not maintained.

The condition of the braking action by the brake pedal being determined to have maintained in this step includes: a brake lamp switch being in position 1, and either the travel of the brake pedal is greater than 3%˜6% (calibratable) or the pressure of the main cylinder is greater than 2 bar 6 bar (calibratable).

M3: determining whether a releasing action of the brake pedal is valid on a basis that M1 and M2 are true; wherein the vacuum pressure is recorded if the releasing action of the brake pedal is valid, which specifically includes:

M31: timing and controlling the counter to add one if the speed of the change of the pressure of the main cylinder is greater than 25 bar/s 50 bar/s (calibrated), and the travel distance of the brake pedal is greater than 10% (calibrated); and timing and controlling the counter to add two if the slope of the change of the pressure of the main cylinder is greater than 50 bar/s 100 bar/s (calibrated), and the travel distance of the brake pedal is greater than 20% (calibrated).

M32: restarting to count if the condition of the M31 is not satisfied in midway any one operation cycle.

M33: obtaining the vacuum pressure instantly when the counter is equal to or greater than 15 (the conversion time is 300 ms and is calibrated).

M4: comparing the vacuum pressure obtained in M3 and the vacuum pressure obtained in M1 to determine whether the vacuum sensor is failed, which specifically includes:

determining whether the vacuum pressure obtained in M3 is within a range of a subtracting of fifteen from the minimum value pabsmin obtained in M1 to a total of fifteen and the maximum value pabsmax obtained in M1; wherein the vacuum sensor is determined to have blockage if yes, namely, if pabsmin−1.5 kPa≤Pact≤pabsmax+1.5 kPa is true; and, the vacuum sensor is determined to have not blockage, and the monitor is closed for 500 ms, namely, the detection is stopped for 500 ms and is restart again.

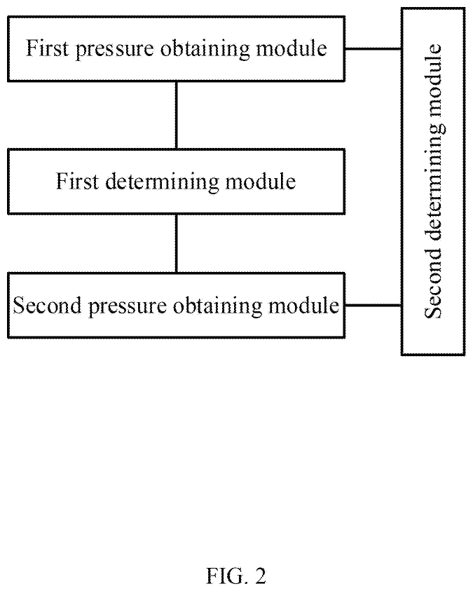

FIG. 2 is a block diagram of an embodiment of a device for failure detection of vacuum sensor. The device includes a first pressure obtaining module, a first determining module, a second pressure obtaining module, and a second determining module, where;

The first pressure obtaining module is configured to obtain a first vacuum pressure when a brake pedal is validly stamped;

The first determining module is configured to determine whether a braking action by the brake pedal is maintained, wherein next S3 is performed during the braking action by the brake pedal being maintained if the braking action by the brake pedal is maintained, and the detection is stopped if the braking action by the brake pedal is not maintained;

The second pressure obtaining module is configured to obtain a second vacuum pressure when the brake pedal is validly released;

The second determining module is configured to determine whether the second vacuum pressure is within a variable range of a first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure.

In one embodiment of the present application, the first pressure obtaining module includes an validity determining unit and a pressure obtaining unit, where:

The validity determining unit is configured to determine that the brake pedal is validly stamped when a pressure of a main cylinder being greater than a preset first threshold, a travel distance of the brake pedal being greater than a preset second threshold, and a speed of a change of the pressure of the main cylinder being greater than a preset third threshold are maintained during a preset period;

The pressure obtaining unit is configured to obtain a maximum vacuum pressure and a minimum vacuum pressure during the preset period.

In one embodiment of the present application, a condition of the braking action by the brake pedal being determined to have maintained in the first determining module includes: a brake lamp switch being on, and either a travel of the brake pedal is greater than a preset fourth threshold or the pressure of the main cylinder is greater than a preset fifth threshold.

In one embodiment of the present application, the second determining module includes a distinguishing unit, a counting unit, and an obtaining unit, where:

When the brake pedal is released, the distinguishing unit is configured to determine that the release is valid and control a counter to add one, if a speed of the change of the pressure of the main cylinder is greater than a preset sixth threshold and the travel distance of the brake pedal is greater than a preset seventh threshold; and determine that the release is valid and control the counter to add two, if the speed of the change of the pressure of the main cylinder is greater than a preset eighth threshold and the travel distance of the brake pedal is greater than a preset ninth threshold;

The counting unit is configured to control the counter to increase from zero, where the counter is reset and restarted from zero if conditions in S31 are not meet when the brake pedal is released;

The obtaining unit is configured to obtain a current vacuum pressure if the counter is greater than a preset tenth threshold.

Content such as information exchange and an execution process between the modules and units in the device is based on a same idea as the method embodiments of the present disclosure. Therefore, for detailed content, refer to descriptions in the method embodiments of the present disclosure, and details are not described herein again.

The disclosure provides a method for failure process of the vacuum sensor, the method includes:

Controlling a vacuum pump to repeat in a cycle of operations comprising closing for a preset duration and opening again when the vacuum sensor is determined to have failed.

In one embodiment of the present application, the method can further limit a highest speed per hour of a vehicle, and generate a failure prompt to the driver, and so on.

In the embodiment, when the vacuum sensor occurs the blockage and failure, the VCU cannot identify a real vacuum degree inside the vacuum booster. At the moment, the vacuum pump is controlled to be on and off intermittently (an interval between on and off is 5 s ˜10 s and is calibrated). On one hand, the vacuum degree inside the booster can be ensured to be a safety level, on the other hand, the vacuum pump can be prevented from continuing for a long time and being burned, thus the safety in traffic can be ensured. When fails, an instrument should prompt that the driver pull over as soon as possible, and the vehicle enters into a speed limit control state. For a vehicle configured with a function of active pressurization of ESP (Electronic Stability Program), the function of the active pressurization of ESP should be started when the driver is required to slow down, thus an assistant brake can be provided and the safety in traffic can be ensured. When the vehicle is blockage and failure, system data related to the vehicle for a period of time before fails and after fails is uploaded in time, thus it is convenient to perform a further search and analyze on the failure.

It should be noted that, in this context, relational terms such as first, second, etc. are used merely to distinguish one entity or operation from another entity or operation, and do not necessarily require or imply any such actual relationship or order between these entities or operations. Furthermore, the term “comprise”, “include”, or any other variants thereof is intended to encompass a non-exclusive inclusion, such that a process, method, article, or device that comprises a plurality of elements not only includes those elements but also includes other elements that are not explicitly listed, or elements that are inherent to such a process, method, item, or device. Without further limitation, an element that is defined by the phrase “comprising a . . . ” does not exclude the presence of additional equivalent elements in the process, method, item, or device that comprises the element.

Those skilled in the art should know that: all or part of the steps of the abovementioned method embodiment may be implemented by instructing related hardware through a program, the abovementioned program may be stored in a computer-readable storage medium, and the program is executed to execute the steps of the abovementioned method embodiment; and the storage medium includes various media capable of storing program codes such as mobile storage equipment, a Read-Only Memory (ROM), a Random Access Memory (RAM), a magnetic disk or an optical disk.

Finally, it should be noted that what described are merely embodiments of the disclosure and are not intended to limit the scope of the disclosure. Any modification, equivalent variation or improvement made without departing from the concept and principle of the present disclosure shall fall within the scope in the disclosure.

1. A method for failure detection of vacuum sensor comprising:
S1: obtaining a first vacuum pressure when a brake pedal is validly stamped;
S2: determining whether a braking action by the brake pedal is maintained, wherein next S3 is performed during the braking action by the brake pedal being maintained if the braking action by the brake pedal is maintained, and a detection is stopped if the braking action by the brake pedal is not maintained;
S3: obtaining a second vacuum pressure when the brake pedal is validly released; and
S4: determining whether the second vacuum pressure is within a variable range of the first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure;
wherein obtaining the second vacuum pressure when the brake pedal is validly released in S3 comprises:
S31: when the brake pedal is released, determining that the release is valid and controlling a counter to add one, if a speed of a change of a pressure of a main cylinder is greater than a preset sixth threshold and a travel distance of the brake pedal is greater than a preset seventh threshold; and determining that the release is valid and controlling the counter to add two, if the speed of the change of the pressure of the main cylinder is greater than a preset eighth threshold and the travel distance of the brake pedal is greater than a preset ninth threshold;
S32: controlling the counter to increase from zero, where the counter is reset and restarted from zero if conditions in S31 are not met when the brake pedal is released;
S33: obtaining a current vacuum pressure if the counter is greater than a preset tenth threshold.

2. The method according to claim 1, wherein the obtaining the first vacuum pressure when the brake pedal is validly stamped in S1 comprises:
S11: determining that the brake pedal is validly stamped when the pressure of the main cylinder being greater than a preset first threshold, the travel distance of the brake pedal being greater than a preset second threshold, and the speed of the change of the pressure of the main cylinder being greater than a preset third threshold are maintained during a preset period; and
S12: obtaining a maximum vacuum pressure and a minimum vacuum pressure during the preset period.

3. The method according to claim 2, wherein a condition of the braking action by the brake pedal being determined to have maintained in S2 comprises:
a brake lamp switch being on, and either a travel of the brake pedal is greater than a preset fourth threshold or the pressure of the main cylinder is greater than a preset fifth threshold.

4-8. (canceled)

9. A method for failure process of vacuum sensor comprising:
S1: obtaining a first vacuum pressure when a brake pedal is validly stamped;
S2: determining whether a braking action by the brake pedal is maintained, wherein next S3 is performed during the braking action by the brake pedal being maintained if the braking action by the brake pedal is maintained, and a detection is stopped if the braking action by the brake pedal is not maintained;
S3: obtaining a second vacuum pressure when the brake pedal is validly released;
S4: determining whether the second vacuum pressure is within a variable range of the first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure; and
controlling a vacuum pump to repeat in a cycle of operations comprising closing for a preset duration and opening again when the vacuum sensor is determined to have failed;
wherein obtaining the second vacuum pressure when the brake pedal is validly released in S3 comprises:
S31: when the brake pedal is released, determining that the release is valid and controlling a counter to add one, if a speed of a change of a pressure of a main cylinder is greater than a preset sixth threshold and a travel distance of the brake pedal is greater than a preset seventh threshold; and determining that the release is valid and controlling the counter to add two, if the speed of the change of the pressure of the main cylinder is greater than a preset eighth threshold and the travel distance of the brake pedal is greater than a preset ninth threshold;
S32: controlling the counter to increase from zero, where the counter is reset and restarted from zero if conditions in S31 are not met when the brake pedal is released;
S33: obtaining a current vacuum pressure if the counter is greater than a preset tenth threshold.

10. The method according to claim 9, wherein the method further comprises:
limiting a highest speed per hour of a vehicle, and/or generate a failure prompt.

11. The method according to claim 9, wherein the obtaining the first vacuum pressure when the brake pedal is validly stamped in S1 comprises:
S11: determining that the brake pedal is validly stamped when the pressure of the main cylinder being greater than a preset first threshold, the travel distance of the brake pedal being greater than a preset second threshold, and the speed of the change of the pressure of the main cylinder being greater than a preset third threshold are maintained during a preset period; and
S12: obtaining a maximum vacuum pressure and a minimum vacuum pressure during the preset period.

12. The method according to claim 11, wherein a condition of the braking action by the brake pedal being determined to have maintained in S2 comprises:
a brake lamp switch being on, and either a travel of the brake pedal is greater than a preset fourth threshold or the pressure of the main cylinder is greater than a preset fifth threshold.

13. A non-transitory storage medium storing a set of commands, when the commands being executed by at least one processor of a vehicle, causing the at least one processor to:
S1: obtain a first vacuum pressure when a brake pedal is validly stamped;
S2: determine whether a braking action by the brake pedal is maintained, wherein next S3 is performed during the braking action by the brake pedal being maintained if the braking action by the brake pedal is maintained, and a detection is stopped if the braking action by the brake pedal is not maintained;
S3: obtain a second vacuum pressure when the brake pedal is validly released; and
S4: determine whether the second vacuum pressure is within a variable range of the first vacuum pressure, wherein the vacuum sensor is determined to have failed if the second vacuum pressure is within the variable range of the first vacuum pressure; and, the vacuum sensor is determined to have not failed if the second vacuum pressure is not within the variable range of the first vacuum pressure;
wherein further cause the at least one processor to:
S31: when the brake pedal is released, determine that the release is valid and control a counter to add one, if a speed of a change of a pressure of a main cylinder is greater than a preset sixth threshold and a travel distance of the brake pedal is greater than a preset seventh threshold;
and determine that the release is valid and control the counter to add two, if the speed of the change of the pressure of the main cylinder is greater than a preset eighth threshold and the travel distance of the brake pedal is greater than a preset ninth threshold;
S32: control the counter to increase from zero, where the counter is reset and restarted from zero if conditions in S31 are not met when the brake pedal is released;
S33: obtain a current vacuum pressure if the counter is greater than a preset tenth threshold.

14. The non-transitory storage medium according to claim 13, further cause the at least one processor to:
S11: determine that the brake pedal is validly stamped when the pressure of the main cylinder being greater than a preset first threshold, the travel distance of the brake pedal being greater than a preset second threshold, and the speed of the change of the pressure of the main cylinder being greater than a preset third threshold are maintained during a preset period; and
S12: obtain a maximum vacuum pressure and a minimum vacuum pressure during the preset period.

15. The non-transitory storage medium according to claim 14, wherein a condition of the braking action by the brake pedal being determined to have maintained in S2 comprises:
a brake lamp switch being on, and either a travel of the brake pedal is greater than a preset fourth threshold or the pressure of the main cylinder is greater than a preset fifth threshold.
